(19) United States
(12) Patent Application Publication
(10) Pub. No.: US 2013/0255134 A1
(43) Pub. Date: Oct. 3, 2013

(54) Article for Controlling Insects in Garbage Containers

(71) Applicant: Dennie Robinson, Muscle Shoals, AL (US)

(72) Inventor: Dennie Robinson, Muscle Shoals, AL (US)

(21) Appl. No.: 13/431,160

(22) Filed: Mar. 27, 2012

(51) Int. Cl. A01M 1/14

(52) U.S. Cl. 43/114

(57) ABSTRACT

The present invention is strip for reducing or eliminating insect infestation in trash containers comprising a generally planer base strip having a first planer surface and a second planer surface, with the first planer surface having an attaching adhesive disposed thereon and the second planer surface having an insect trapping material disposed thereon, wherein in said trapping material has an outer surface portion constructed and arranged for trapping flying and crawling insects.

### BACKGROUND OF THE INVENTION

### Field of the Invention

Insect infestation in areas where trash is stored is a common problem in our society. Although there have been many advances in order to alleviate this situation, there still is a significant problem associated therewith. The insects not only provide an unpleasant atmosphere, but also pose a significant health risk. Although most people have tried to eliminate insect problems around trash by merely providing lids, lids have in fact, provided mixed results. There is a need to provide an article that will help reduce or eliminate insect infestation around trash storage articles. The concept of insect flypaper is well known, however, anyone that has worked with insect flypaper knows that it sometimes becomes difficult to handle due to the inherent lack of rigidity in the paper. Flypaper would not provide a useable surface to be used with trash receptacles due to its inherent flexibility.

### SUMMARY OF THE INVENTION

The present invention has provided a strip with sufficient rigidity such that it can be handled and affixed to various surfaces. For example, the strip of the present invention can be affixed to plastic and paper trash bags as are commonly used. Further, the strip of the present invention can be affixed to either the inner or outer perimeter of these trash bags. In another embodiment, the strip of the present invention can be affixed to either the inner or outer perimeter of an outdoor trash receptacle. In all of these uses, the strip is an article that is part of a system by which insect infestation in and around trash receptacles are eliminated and/or reduced.

In one embodiment, the present invention is a strip for reducing or eliminating insect infestation in trash containers comprising a generally planer base strip, said base strip having a first planer surface and a second planer surface;
said first planer surface having an attaching adhesive disposed thereon;
said second planer surface having an insect trapping material disposed thereon, wherein in said trapping material has an outer surface portion constructed and arranged for trapping flying and crawling insects.

The strip attaching adhesive is selectively formulated to adhere to a desired surface, including, but not limited to, plastic bags, paper bags, metal surfaces, hard plastic surfaces, and/or combinations thereof

The trapping material is disposed on substantially all of said second planer surface.

In one embodiment, the second planer further includes an insect attractant, a deodorizing material and/or combinations thereof.

In one embodiment, the attractant is free from arsenide compounds.

### BRIEF DESCRIPTION OF THE SEVERAL VIEWS OF THE DRAWING

FIG. 1 is a perspective view of an environment of use of the present invention.

FIG. 2 is a section from section lines A-A of FIG. 1.

FIG. 3 is a section from section B-B of FIG. 1.

FIG. 4 is a perspective view.

FIG. 5 is a section of C-C of FIG. 4.

FIG. 6 is a perspective view.

FIG. 7 is a section view from section lines D-D of FIG. 6.

### DETAILED DESCRIPTION OF THE PREFERRED EMBODIMENT

Trash bag system 10 includes a trash bag 1 in which an adhesive strip 3 is attached thereto. Adhesive strip 3 has an inside adhesive surface 6. Inside adhesive surface 6 is exposed by removing a removable backing and exposing surface 6. Adhesive surface 6 is formulated to adhere to trash bag 1. Adhesive strip 3 further has a removable backing 4 whereby said removable backing exposes insect adhesive 5. Insect adhesive 5 is exposed to the environment such that insects that encounter adhesive 5 will adhere thereto.

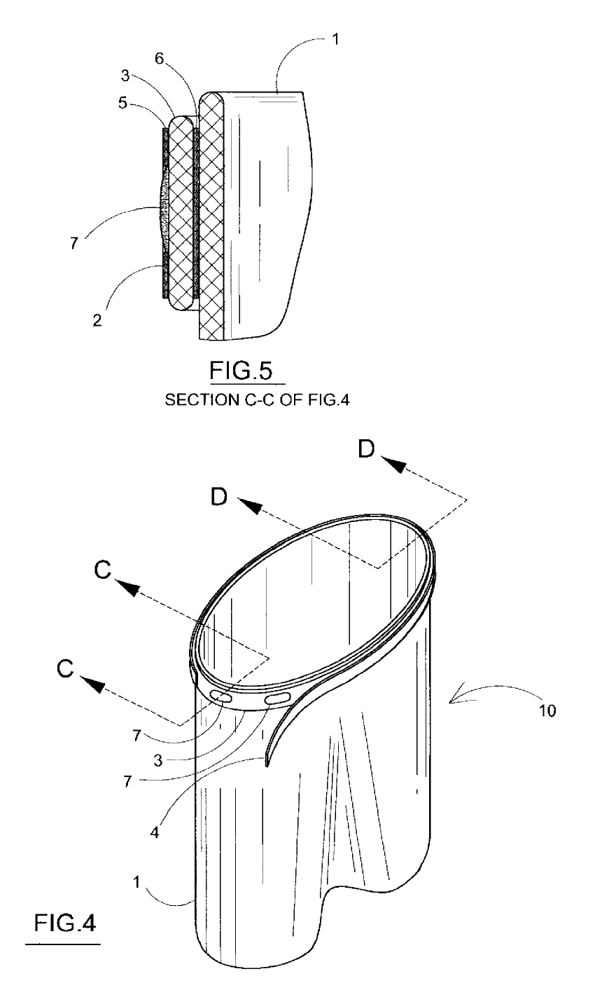

In one embodiment as best seen in FIGS. 4 and 5 adhesive surface 5 further includes an additional material 7. Additional material 7 is deodorizer, insect attractant, or combinations thereof.

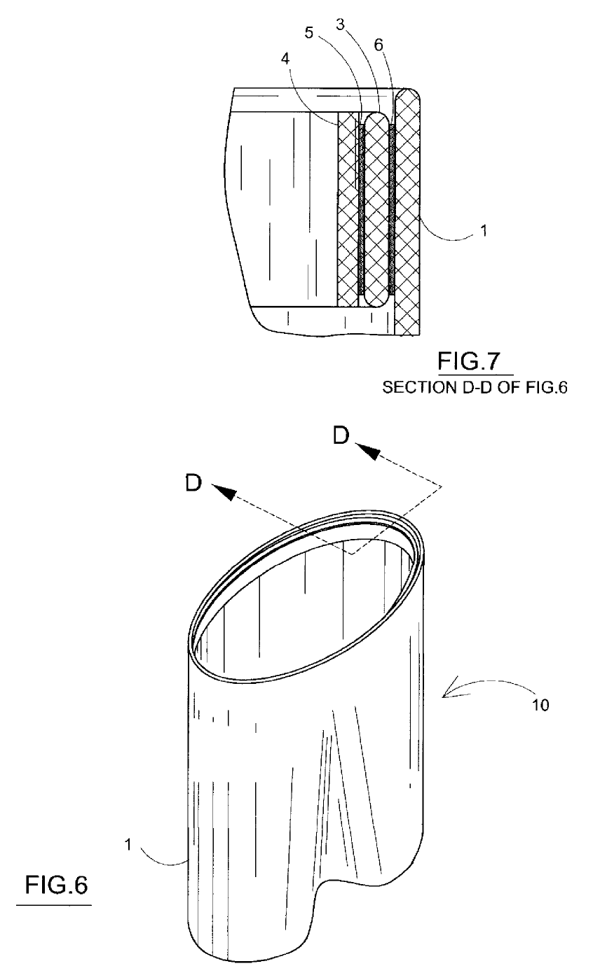

In an embodiment shown in FIGS. 6 and 7, adhesive strip 3 of the present invention is positioned and secured along the interior perimeter of trash bag 1.

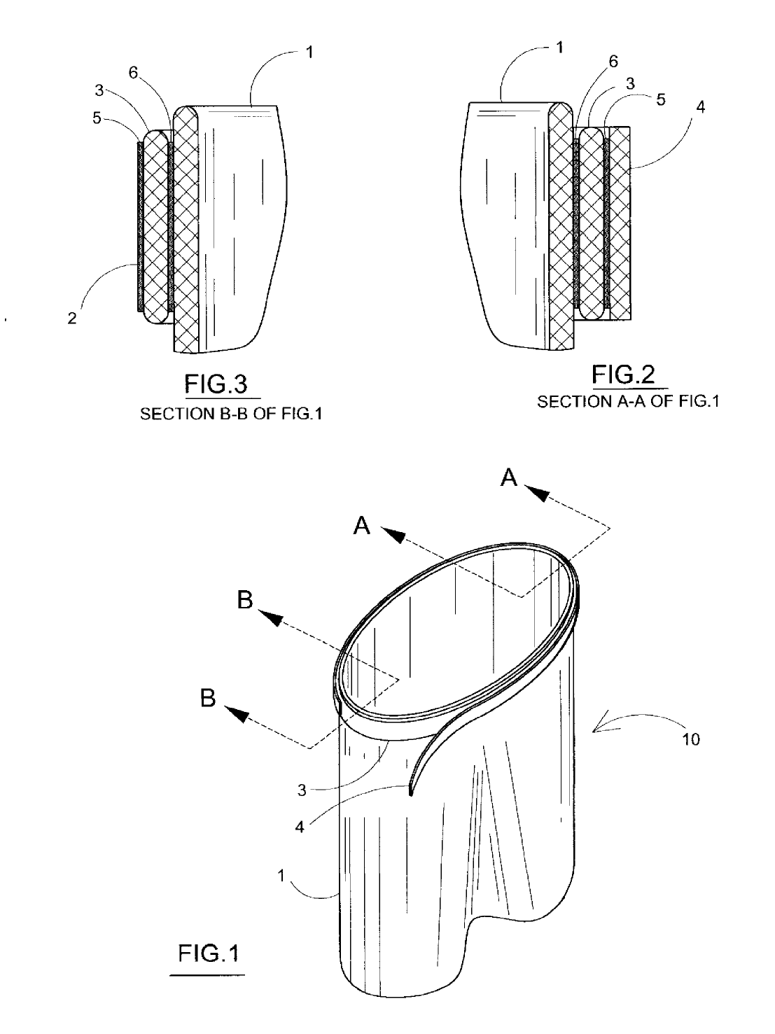

In an environment of use a user identifies a trash receptacle in need of insect capture and/or repelling features. The present invention can be secured to the outer perimeter of a trash receptacle, the inner perimeter of a trash receptacle, or both. Although the disclosed embodiments depict affixing an article of the present invention to a trash bag, it is not intended to be limited solely to trash bags. Articles of the present invention can be secured to outdoor dumpsters, outdoor trash receptacles and the like in order to reduce and/or eliminate the presence of insects around trash containers. A user is provided with strip 3 according to present invention strip 3 has at least one removable backing 4. As is known is the art, with such articles as double faced tape, it is not required that two separate backings be provided in order to transport and ultimately use strip 3 of the present invention. In one embodiment there is only one removable strip 4 in strip 3 of the present invention. However, in another embodiment, a second removable strip, which would be placed over inner adhesive 6 is used. A user will receive strip 3 and remove backing 4. The user will then position and affix strip 3 to the article desired. In embodiment shown in FIGS. 1-5, strip 3 is affixed to the exterior perimeter of a trash bag.

In the embodiment shown in FIGS. 6 and 7, strip 3 is affixed to the interior of trash bag 1. Strip 3 can be constructed and arranged using appropriate adhesive 6 dependent on an intended environment of use. Adhesive 6 will be formulated to adhere to plastic or paper trash bags if such use in intended by an end user. In an embodiment where strip 3 will be adhered to a dumpster or outdoor metal or plastic trash receptacle, adhesive 6 is formulated appropriately. Strip 3 has deposed thereon a material 5, material 5 having a thickness and terminating with material surface 2. Material surface 2 is appropriately formulated to include materials for trapping insects thereon. The materials include trapping materials with a tack value and adhesives that are suitable for attracting and trapping insects thereon. An insect will either fly or crawl onto surface 2 and become trapped thereon.

As is known in the art, secondary material 7, as shown in FIG. 5, is disposed on surface 2. Secondary material 7 may include any one or combinations of an insect attractant (such as pheromones and the like), a deodorizer, or other materials as desired. Secondary material 7 is disposed in a manner such that it does not disrupt the overall adhesive quality of surface 2. Therefore, although shown as a somewhat unitary form in FIG. 5, material 7 in inter dispersed upon and throughout surface 2 such that the overall adhesive quality of surface 2 is not disrupted. Adhesive 5 and secondary material 7, in one embodiment, are formulated for outdoor use. As is known in the art, outdoor adhesives and attractant or other secondary materials must be properly formulated to withstand environmental conditions.

In one embodiment, the second planer side is coated with one or materials free of metallic arsenic.

In another embodiment, the second planer side of strip 3 is coated with non-toxic materials for trapping insects thereon.

An alternative embodiment includes using one or more strips according to the present invention that are positioned either on the inner perimeter, outer perimeter, or combinations thereof. The strips can be placed in patterns or in succession with space between successive strips such that a portion of the perimeter has strips affixed thereto.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A strip for reducing or eliminating insect infestation in trash containers comprising a generally planer base strip, said base strip having a first planer surface and a second planer surface;
said first planer surface having an attaching adhesive disposed thereon;
said second planer surface having an insect trapping material disposed thereon, wherein in said trapping material has an outer surface portion constructed and arranged for trapping flying and crawling insects.

2. The strip of claim 1 wherein said attaching adhesive is formulated to adhere to plastic bags.

3. The strip of claim 1 wherein said attaching adhesive is formulated to adhere to paper bags.

4. The strip of claim 1 wherein said attaching adhesive is formulated to adhere to metal surfaces.

5. The strip of claim 1 wherein said attaching adhesive is formulated to adhere to hard plastic surfaces.

6. The strip of claim 1 wherein said trapping material is disposed on substantially all of said second planer surface.

7. The strip of claim 1 wherein said second planer further includes an insect attractant.

8. The strip of claim 1 wherein said second planer further includes a deodorizing material.

9. The strip of claim 7 wherein said attractant is free from arsenide compounds.
